(19) United States
(12) Patent Application Publication
(10) Pub. No.: US 2016/0357927 A1
(43) Pub. Date: Dec. 8, 2016

(54) ADVICE PROVIDING SYSTEM, ADVICE PROVIDING APPARATUS, ADVICE PROVIDING SERVER, AND METHOD OF PROVIDING ADVICE

(71) Applicant: SEIKO EPSON CORPORATION, Tokyo (JP)

(72) Inventor: Masakazu ISOMURA, Kai-shi (JP)

(73) Assignee: SEIKO EPSON CORPORATION, Tokyo (JP)

(21) Appl. No.: 15/171,729

(22) Filed: Jun. 2, 2016

(30) Foreign Application Priority Data
Jun. 4, 2015 (JP) 2015-113727

(51) Int. Cl. G06F 19/00; G06F 3/0484; G06F 3/0482

(52) U.S. Cl. CPC G06F 19/3418; G06F 19/323; G06F 3/0482; G06F 3/04842

(57) ABSTRACT

An advice providing system includes: an advice storage device in which analysis information that results from analysis based on exercise data of a subject, specific information of the subject, and provision advice that is provided to the subject are stored associated with one another; an advice retrieval unit that retrieves at least one advice candidate from the pieces of advice, based on at least one piece of information of the analysis information and the specific information; and a determiner that determines edit advice that results from performing editing referring to the advice candidate, as provision advice that is provided to the subject, in which, in a case where a difference between the provision advice and the advice candidate exceeds a predetermined amount, the provision advice is stored, associated with the analysis information and the specific information.

### CROSS-REFERENCES TO RELATED APPLICATIONS

This application claims priority to Japanese Patent Application No. 2015-113727, filed Jun. 4, 2015, the entirety of which is herein incorporated by reference.

### BACKGROUND

1. Technical Field

The present invention relates to an advice providing system, an advice providing apparatus, an advice providing server, and a method of providing advice.

2. Related Art

In the related art, for example, as disclosed in JP-A-2008-262504, an advice providing apparatus is known that analyzes health-care management data which is obtained from a vital measurement apparatus which is used by a subject, and reports advice information associated with analysis information to the subject.

However, in the advice providing apparatus in the related art, which is disclosed in JP-A-2008-262504, because a monotonous sentence expression is used, there is a problem in that the advice information which is provided gives the non-emotional impression that the advice information is created mechanically. More specifically, the advice providing apparatus in the related art includes an advice information table in which advice statements are defined in advance, and provides the advice statement that corresponds to the analysis information that results from analyzing the health-care management data of the subject. To be more precise, the same advice statement is repeatedly provided during a period of time during which there is little change in the analysis information. In this manner, the advice information that, due to the monotonous sentence expression, gives the non-emotional impression that the advice information is mechanically created is repeatedly provided to the subject and thus the subject's willingness to accept the advice and take the corresponding action for improvement is decreased.

Furthermore, a method is considered in which the analysis information is subdivided into components and in which the advice statement is defined in advance in an advice information table, using a sentence expression that corresponds to each of the components. However, in this method, because the number of the advice statements of which the definitions are necessary increases and a job of creating the statements that depend on all situations is enormous, it is unrealistic to embody a system.

### SUMMARY

An advantage of some aspects of the invention is to solve at least a part of the problems described above, and the invention can be implemented as the following forms or application examples.

### Application Example 1

An advice providing system according to this application example includes: an advice storage device in which analysis information that results from analysis based on exercise data of a subject, specific information of the subject, and advice information that is provided to the subject are stored associated with one another; an advice retrieval unit that retrieves at least one advice candidate from the advice storage unit, based on at least one piece of information of the analysis information and the specific information; and a determiner that determines edit advice that results from performing editing referring to the advice candidate, as provision advice that is provided to the subject.

According to this application example, the advice candidate from the advice storage unit in which the pieces of provision advice that are provided to the subject are stored can be referred to, the advice candidate can be edited, and the provision advice that is provided to the subject can be generated. Because the provision advice that is newly generated is created referring to pieces of advice in various expressions that are already provided to the subject, the editing can be performed while avoiding a monotonous sentence expression, and the concern that the advice that gives the non-emotional impression that the advice is created mechanically is repeatedly provided to the subject is reduced.

Furthermore, according to this application example, because the pieces of advice that are provided are stored and accumulated in the advice storage unit, there is no need to create a large number of the advice statements in advance. To be more precise, the system is easier to realize than an apparatus in the related art.

### Application Example 2

It is preferable that the provision advice in the application example is stored in the advice storage unit, in a state of being associated with the analysis information and the specific information, in a case where a difference between the provision advice and the advice candidate exceeds a predetermined amount.

According to this application example, in a case where a difference in contents between the provision advice and the advice candidate is small, because the storage in the advice storage unit is not performed, there is also an effect that suppresses an increase in an amount of advice information that is stored in the advice storage unit.

### Application Example 3

It is preferable that the advice providing system according to the application example further includes: an advice candidate display unit on which the advice candidate is displayed; and an editing unit that selects one from among the displayed advice candidates, deletes, adds, or changes one portion or all portions of a statement that is included in the selected advice candidate, and thus generates the edit advice.

According to this application example, because the advice candidate is displayed on the advice candidate display unit and the selected advice candidate can be edited, the provision advice in a statement that is different from the advice candidate that has already been provided can be created. Furthermore, a job of easily performing editing in an easy-to-understand manner is possible.

### Application Example 4

It is preferable that the advice providing system according to the application example further includes: a detector that detects the exercise data of the subject; and a provision advice display unit on which the provision advice that is created based on the exercise data is displayed.

According to this application example, for example, the exercise data for analyzing the analysis information can be preferentially selected and detected by including the detector in the advice providing system. Accordingly, the detection of unnecessary information relating to the detector is suppressed, and thus power consumption can be reduced or a configuration of the detector can be simplified.

Furthermore, the provision advice that corresponds to the detected exercise data can be displayed for the subject of which the exercise data is detected, by including the provision advice display unit in the advice providing system. Because the subject easily looks back on an exercise situation relating to the provision advice, the provision advice can be expected to lead to active action for improvement by the subject.

### Application Example 5

It is preferable that the specific information in the application example includes at least one among an identification number for identifying the subject, a full name, a height, a weight, a birth date, a gender, a district, an exercise purpose, job information, and disease information.

### Application Example 6

It is preferable that the exercise data in the application example includes at least one among the number of days on which exercise takes place, an amount of exercise time, exercise intensity, consumed calories, and a tendency for weight to change, an amount of device-wearing time, and an amount of zone-staying time.

### Application Example 7

It is preferable that the advice providing system according to the application example includes: a terminal device that includes the detector, the provision advice display unit and a terminal communicator that transmits the exercise data and receives the provision advice; an advice providing apparatus that includes the advice candidate display unit, the editing unit, the determiner, and a provision apparatus communicator that receives the advice candidate and transmits the provision advice, and an advice providing server that includes the advice storage unit, the advice retrieval unit, and a server communicator that receives the exercise data, transmits the advice candidate, and transmits and receives the provision advice.

According to this application example, the functions are distributed by each of the terminal device, the advice providing apparatus, and the advice providing server, and thus the effect of improving efficiency, which is described above, can be obtained.

For example, the terminal device can be made to be small and can be carried by the subject. The advice providing apparatus can be set to be an apparatus that includes the display which is so suitably sized that the advice is easy to edit and that is used by a mentor or another person who guides the subject. The advice providing server can be set to be a server that is installed in a server room or the like where the data is able to be safely retained.

### Application Example 8

An advice providing apparatus according to this application example constitutes an advice providing system that includes an advice storage unit in which analysis information that results from analysis based on exercise data of a subject, specific information of the subject, and advice information that is provided to the subject are stored associated with one another, an advice retrieval unit that retrieves at least one advice candidate from the advice storage unit based on at least one piece of information of the analysis information and the specific information, and a determiner that determines edit advice that results from performing editing referring to the advice candidate, as provision advice that is provided to the subject. The advice providing apparatus includes: an advice candidate display unit on which the advice candidate is displayed; an editing unit that selects one from among the displayed advice candidates, deletes, adds, or changes one portion or all portions of a statement that is included in the selected advice candidate, and thus generates the edit advice; and the determiner.

According to this application example, the advice providing apparatus can determine the edit advice that results from the editing unit performing editing referring to the advice candidate that is displayed on the advice candidate display unit, as the provision advice that is provided to the subject, using the determiner. The advice candidate is an advice candidate that is retrieved from the pieces of provision advice that are already provided to the subject.

Therefore, because the provision advice that is determined by the advice providing apparatus is created referring to various pieces of advice that are already provided to the subject, the editing can be performed while avoiding a monotonous sentence expression, and the concern that the advice that gives the non-emotional impression that the advice is created mechanically is repeatedly provided to the subject is reduced.

### Application Example 9

An advice providing server according to the application example constitutes an advice providing system including an advice storage device in which analysis information that results from analysis based on exercise data of a subject, specific information of the subject, and advice information that is provided to the subject are stored associated with one another; an advice retrieval unit that retrieves at least one advice candidate from the advice storage unit, based on at least one piece of information of the analysis information and the specific information; and a determiner that determines edit advice that results from performing editing referring to the advice candidate, as provision advice that is provided to the subject. The advice providing server includes the advice storage unit and the advice retrieval unit.

According to this application example, the advice providing server can retrieve the advice candidate from the advice storage unit in which the pieces of the provision advice that are provided to the subject are stored, using the advice retrieval unit. The retrieved advice candidate is transmitted, and thus in a reception destination, it is possible to create new provision advice referring to the advice candidate.

Therefore, because the provision advice that is created from the advice candidate which is transmitted by the advice providing server is created referring to various pieces of advice that are already provided to the subject, the editing can be performed while avoiding a monotonous sentence expression, and the concern that the advice that gives the non-emotional impression that the advice is created mechanically is repeatedly provided to the subject is reduced.

### Application Example 10

A method of providing advice according to the application example includes: storing analysis information that results from analysis based on exercise data of a subject, specific information of the subject, and advice information that is provided to the subject, which are associated with one another, in a database; retrieving at least one advice candidate from the database, based on at least one piece of information of the analysis information and the specific information; and determining edit advice that results from performing editing referring to the advice candidate, as provision advice that is provided to the subject.

According to this application example, the advice candidate from the database in which the pieces of provision advice that are provided to the subject are stored can be referred to, the advice candidate can be edited, and the provision advice that is provided to the subject can be generated. Because the provision advice that is newly generated is created referring to pieces of advice in various expressions that are already provided to the subject, the editing can be performed while avoiding a monotonous sentence expression, and the concern that the advice that gives the non-emotional impression that the advice is created mechanically is repeatedly provided to the subject is reduced.

### BRIEF DESCRIPTION OF THE DRAWINGS

The invention will be described with reference to the accompanying drawings, wherein like numbers reference like elements.

FIG. 1 is an explanatory diagram representing an outline of an advice providing system.

FIG. 2 is a diagram for describing schematic functions of main portions of the advice providing system.

FIG. 3 is a block diagram illustrating a schematic configuration of the advice providing system.

FIG. 4 is an entity-relationship diagram illustrating a relationship with a database table of an advice provision server.

FIG. 5 is a sequence diagram illustrating a schematic sequence for the advice providing system.

FIG. 6 is a diagram illustrating one example of a subject information display screen.

FIG. 7 is a diagram illustrating one example of a creation instruction screen.

FIG. 8 is a diagram illustrating one example of a retrieval instruction screen.

FIG. 9 is a diagram illustrating one example of an advice candidate display screen.

FIG. 10 is a diagram illustrating one example of an address editing screen.

FIG. 11 is an explanatory diagram illustrating an outline of a terminal device according to a first modification example.

### DESCRIPTION OF EXEMPLARY EMBODIMENTS

Embodiments of the invention will be described below referring to the drawings. Moreover, because layers and members in the following drawings are enlarged in such an extent that they are recognizable, their scales are different from those in the real world.

### First Embodiment

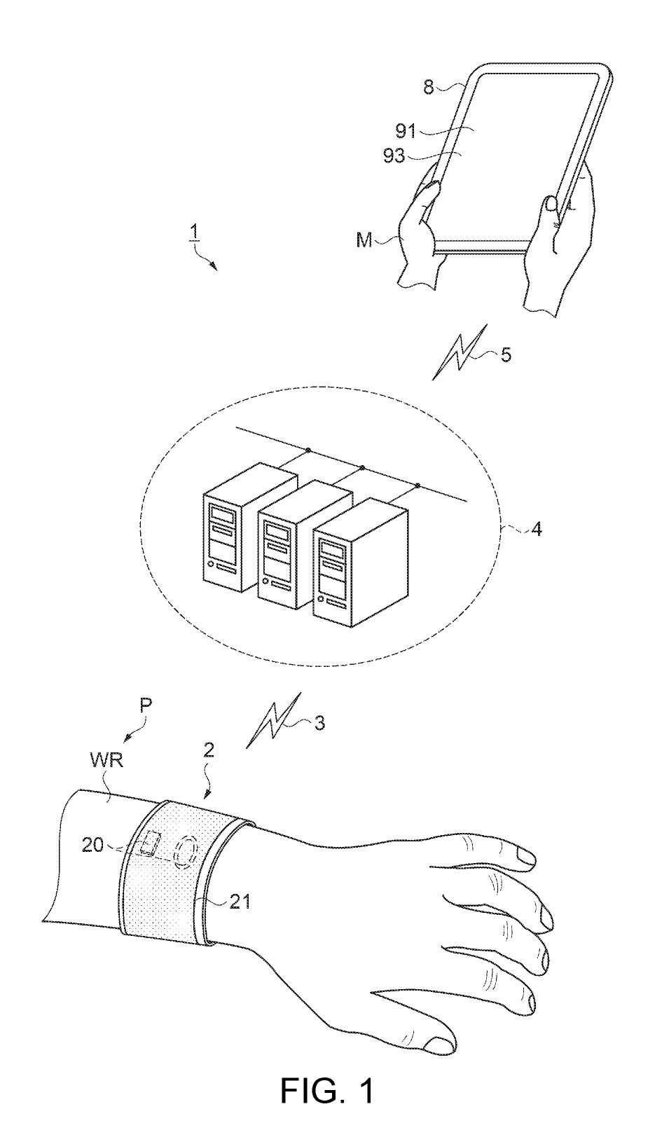

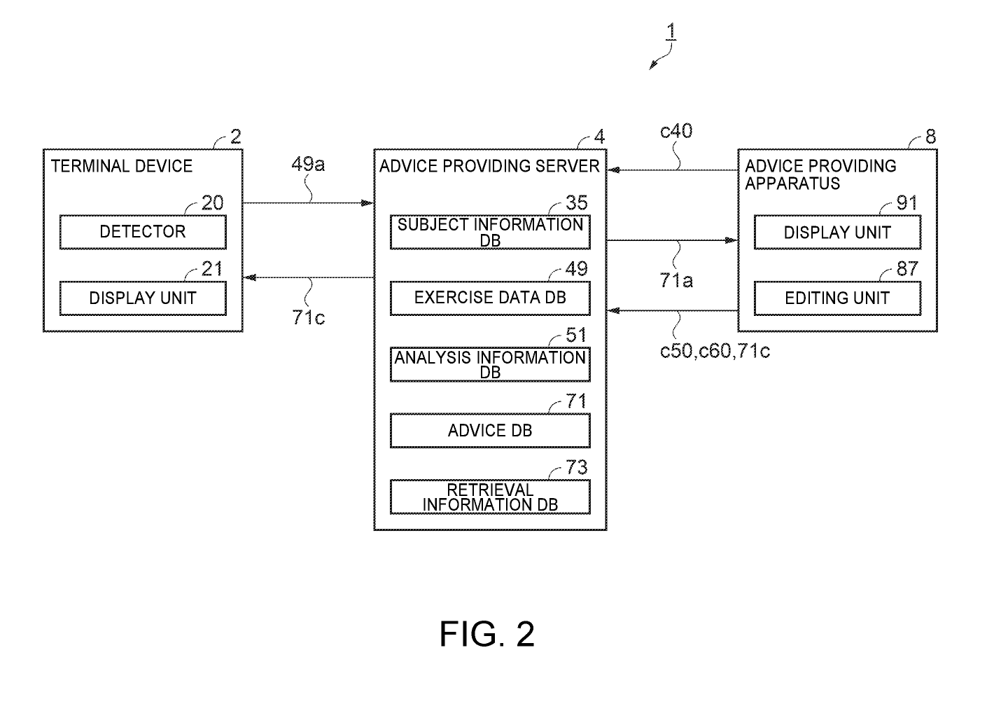

First, an outline of the present embodiment is referring primarily to FIG. 1 and secondarily to FIGS. 2, 9 and 10.

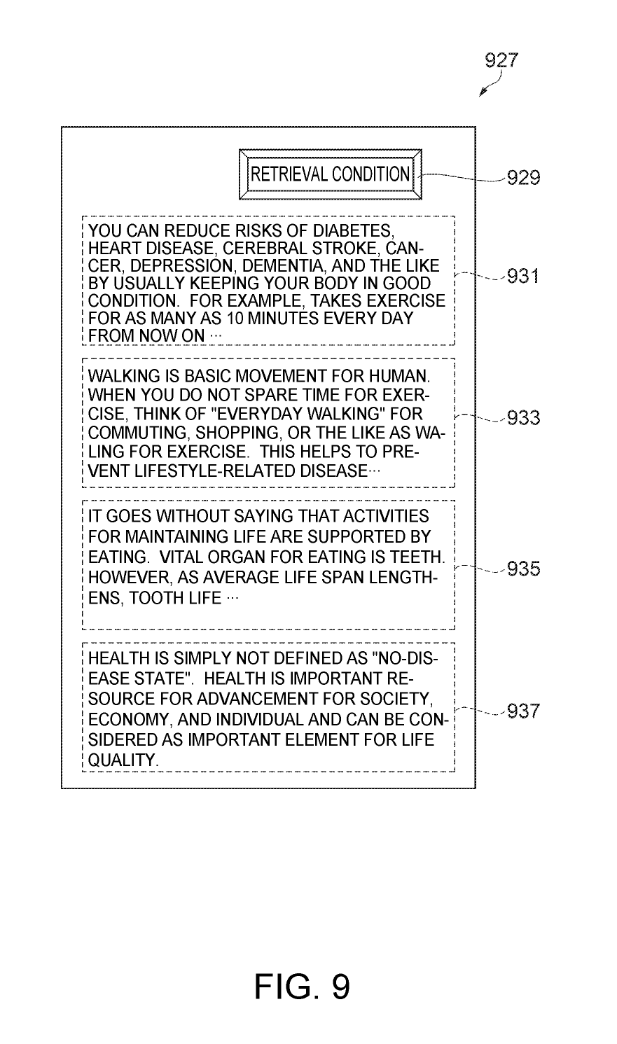

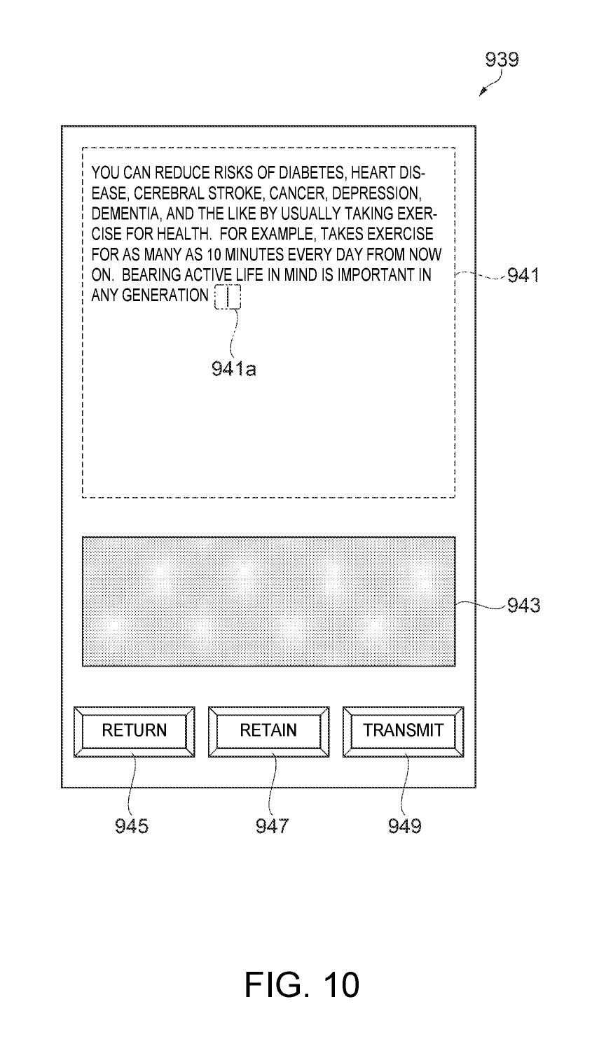

FIG. 1 is an explanatory diagram representing an outline of an advice providing system. FIG. 2 is a diagram for describing schematic functions of main portions of the advice providing system. FIG. 9 is a diagram illustrating one example of an advice candidate display screen. FIG. 10 is a diagram illustrating one example of an advice editing screen.

An advice providing system 1 that is illustrated in FIG. 1 provides advice adequate for a subject P, and thus supports behavior for an improvement in health or athletic ability of the subject P. Furthermore, the advice providing system 1 is a system that supports a job of editing advice that is created by a mentor M that offers guidance on the improvement in the health or athletic ability of the subject P.

The advice providing system 1 is configured to include a terminal device 2 that is worn on the subject P, an advice providing server 4 that is installed in a server room or the like, an advice providing apparatus 8 that is used by the mentor M, and the like.

The terminal device 2 is a wristwatch-type terminal device that is worn on a wrist WR of the subject P. A detector 20 that detects exercise data of the subject P is built into the terminal device 2. A display unit 21 on which an advice statement for the subject P is displayed is arranged in such a manner that the display unit 21 is exposed toward the opposite side from the wrist WR.

The advice providing server 4 is one or more servers that are configured to include a database engine and the like, and realizes each function with a processor that will be described below, without being limited to only a service of providing accumulated pieces of data. The server is connected to a network. The advice providing server 4 and the terminal device 2 are connected to each other in such a manner as to transmit and receive various pieces of data to and from each other with communication 3.

The advice providing apparatus 8 is a general purpose tablet terminal, a general purpose computer (PC), or the like that is used by the mentor M, and includes a display unit 91 on which the advice statement is editable, an operation unit 93, and the like. The advice providing apparatus 8 and the advice providing server 4 are connected to each other in such a manner as to transmit and receive various pieces of data to and from each other with communication 5.

A description is provided referring to FIG. 2.

The advice providing server 4 includes databases, that is, a subject information DB 35 in which specific information of the subject P is managed, an exercise data DB 49 in which exercise data is managed, an analysis information DB 51 in which analysis information that results from analyzing the exercise data is managed, an advice DB 71 in which advice information that is provided to the subject P is managed, and a retrieval information DB 73 that has retrieval information on the advice information.

In the terminal device 2, the exercise data of the subject P that is detected in the detector 20 is transmitted, as exercise data 49a, to the advice providing server 4.

In the advice providing server 4, the received exercise data 49a is stored in the exercise data DB 49. When pieces of exercise data 49a are accumulated over a predetermined period of time, the advice providing server 4 has a function of analyzing the accumulated pieces of exercise data 49a and generating the analysis information. The analysis information is stored in the analysis information DB 51. Moreover, the analysis information on a predetermined amount of exercise data or on the exercise information that is measured during one-time training may be generated without being limited to the predetermined period of time.

In the advice providing apparatus 8, the advice information for the subject P is generated by the mentor M. When a period of time has elapsed during a period of time during which an exercise program for the subject P is carried out, the mentor M operates the advice providing apparatus 8 and generates the advice information to be provided to the subject P.

When a job of generating the advice information for the subject P is started by the mentor M, the advice providing apparatus 8 transmits a command c40 to request an advice candidate to the advice providing server 4 and waits for a response. Moreover, at the time of the transmission of the command c40, pieces of information corresponding to the advice information that is generated, such as the exercise data, the analysis information, and the specific information, are shared between the advice providing server 4 and the advice providing apparatus 8.

In the advice providing server 4, when the command c40 is received, the advice candidate is retrieved from the retrieval information DB 73, a result of the retrieval is transmitted (is sent in response), as an advice candidate 71a, to the advice providing apparatus 8.

In the advice providing apparatus 8, when the advice candidate 71a is received (received in response) from the advice providing server 4, a list of the advice candidates 71a is displayed on the display unit 91. A display example of the advice candidate 71a is displayed on an advice candidate display screen 927 (FIG. 9).

In the advice providing apparatus 8, when the advice statement that is the most suitable as the exercise data of the subject P is selected by the mentor M from among the advice candidates 71a that are displayed on the advice candidate display screen 927, processing is transferred by an editing unit 87 and the selected advice statement is editable. A display example of the advice statement (an edit advice) in an editing state is displayed on the advice editing screen 939 (FIG. 10). When the editing by the mentor M is finished, the edit advice is determined as a provision advice 71c that is provided to the subject. The provision advice 71c is transmitted together with a command c50 to indicate that the provision advice 71c has to be registered in the advice providing server 4, and a command c60 to indicate that the provision advice 71c has to be transmitted to the terminal device 2, to the advice providing server 4.

In the advice providing server 4, the provision advice 71c is stored in the advice DB 71 by the reception of the command c50. Then, the provision advice 71c is transmitted to the terminal device 2 by the reception of the command c60.

In the terminal device 2, the received provision advice 71c is displayed on the display unit 21.

In this manner, the advice information that is edited by the mentor M is provided to the subject P. The advice information is generated as a statement or a sentence expression that is edited by the mentor M, not as a statement that is auto-generated mechanically. In an advice providing apparatus in the related art, in some cases, the same statements or the same sentence expressions are repeatedly provided because a fixed-form sentence in accordance with the analysis information is displayed. In contrast, because the advice statement that is provided by the advice providing apparatus 8 is edited by the mentor M, it is possible to change the statement that was provided in the past, to a different expression or to a fresh sentence expression that is created by the subject P. Additionally, because the advice candidate is retrieved using the analysis information and the specific information, the advice candidate is a statement that expresses a similar situation, and a statement that is easy for the mentor M to edit is selected. The mentor M can create the advice statement for the subject P more easily than newly creating the advice statement.

Furthermore, the provision advice 71c that is edited by the mentor M is stored in the advice DB 71, the advice statements that are various sentence expressions are accumulated in the advice DB 71. A configuration of the advice providing system 1 for realizing this effect will be described in detail below referring to the drawings.

### Configuration of the Advice Providing System

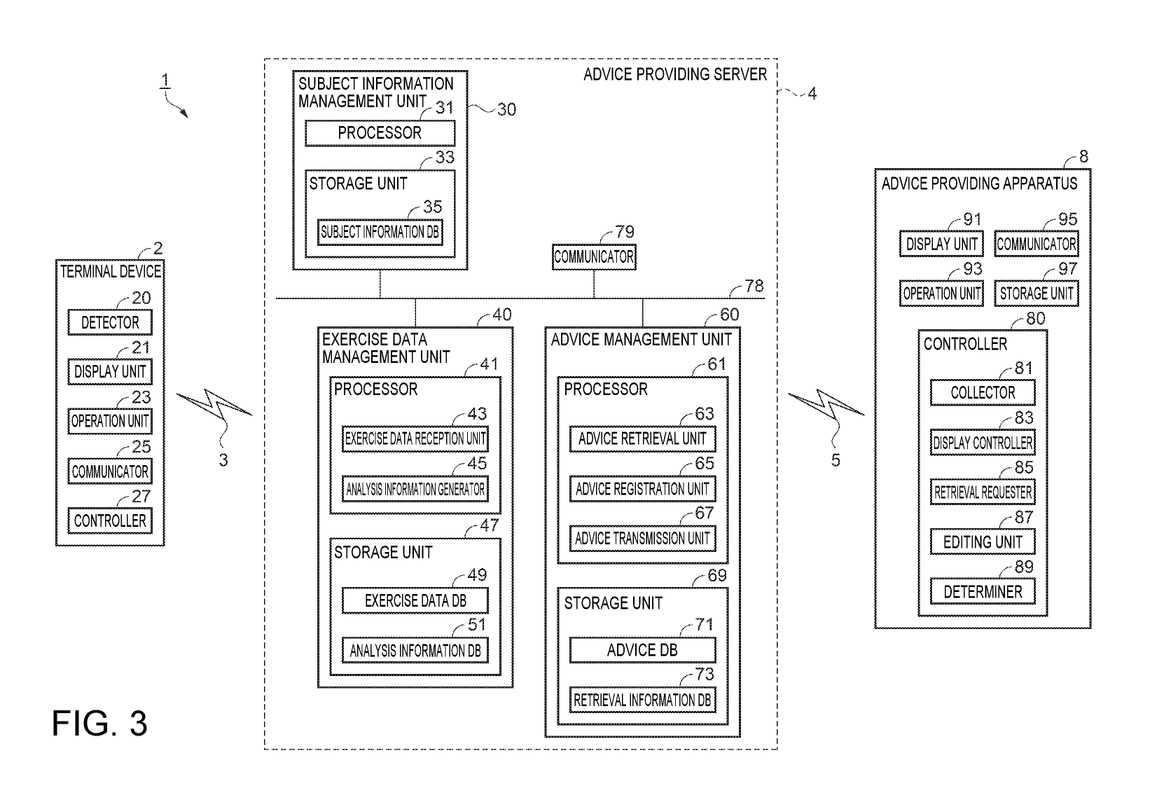

FIG. 3 is a block diagram illustrating a schematic configuration of the advice providing system.

The advice providing system 1 is configured from the terminal device 2, the advice providing server 4, the advice providing apparatus 8, and the like.

### Configuration of the Terminal Device

The terminal device 2 is configured from the detector 20, the display unit 21, an operation unit 23, a communicator 25, a controller 27, and the like.

As a suitable example, the detector 20 is a sensor unit that is configured to include a pulse wave sensor, an acceleration sensor, a gyroscope sensor, and a global positioning system (GPS) sensor (none of which is illustrated). However, no limitation to this configuration is imposed, and any sensor may be available that is able to collect posture information, positional information, environmental information and exercise state information of the subject P who wears the terminal device 2.

The pulse wave sensor has a light emitting element, such as a light emitting diode (LED) and a light receiving element, such as a photodiode. Light that is reflected by the light emitting element is reflected at a blood vessel of the wrist WR. The reflected light is collected and received in the light receiving element. The pulse wave sensor detects a pulse wave of the subject P from information on a change in an amount of received light, using a phenomenon in which light reflection rates differs when the blood vessel expands and when the blood vessel contracts. Based on data on the pulse wave that is detected, the controller 27 (which will be described below) calculates pieces of exercise data, such as a pulse rate, consumed calories that are derived from the pulse rate, an amount of exercise time, and exercise intensity. Furthermore, based on an output signal of the pulse wave sensor, a period of time for which a pulse wave signal is detected may be calculated as an amount of device-wearing time.

The acceleration sensor is an acceleration sensor that is attached in an axis direction of one axis or in axis directions of two or more axes (for example, three-axis directions of X, Y, and Z axes), and measures a change in acceleration along each axis per unit time.

The gyroscope sensor measures an angular velocity per unit time with X, Y, and X axes as central axes in the acceleration sensor. The acceleration sensor and the gyroscope sensor add up amounts of changes in the acceleration and the angular velocity and calculate the exercise intensity and an amount of exercise in accordance with the amounts of changes, using pieces of data on the changes in the acceleration and the angular velocity that are detected. The amount of exercise time, the number of days on which the exercise takes place, or the like is calculated with the exercise intensity and the amount of exercise that are obtained in this manner.

The GPS sensor includes a GPS reception function and a positional information computing circuit, and measures positional information (latitude, longitude, and altitude) data per unit time. A movement distance or a movement speed is calculated from the positional information per unit time, and the amount of exercise for the subject P is calculated by combining the calculated movement distance or movement speed and pieces of information of other sensors.

Furthermore, additionally, an environmental sensor, such as a temperature sensor or a pressure sensor, may be included, and environmental information, such as a temperature or a pressure in the neighborhood of the terminal device 2 may be collected.

Furthermore, the detector 20 is not limited to one that is built into the terminal device 2, and may be configured to acquire various pieces of information including physical information and the like that are measured by a different apparatus, as the exercise data, by communicating with the different apparatus such as a weight measuring instrument, a height measuring instrument, a treadmill or an exercise bike that is installed in a sport gym, or the like. In this case, the detector 20 maybe configured to transmit measurement data from the different apparatus to the terminal device 2, and to transmit the measurement data from the terminal device to the advice providing server 4, and may be configured to transmit the measurement data from the different apparatus directly to the advice providing server 4.

The display unit 21 is a display device on which a character or an icon are able to be displayed, and is, for example, a flexible-type dot-matrix electrophoretic display (EPD) that is able to be flexibly shape-changed. Based on a display signal that is output from the controller 27, information such as the advice statement is displayed. Moreover, the display unit 21 is equivalent to a provision advice display unit.

The operation unit 23 is an input device that is configured to have a touch sensor, a touch panel, or the like, is installed on a surface of the display unit 21, detects a touched-on portion using a electrostatic capacitance method, a resistance film method, or the like, and outputs a detection signal to the controller 27.

As a suitable example, the communicator 25 is a short-distance wireless adapter, has a communication protocol that is common between the communicator 25 and a communicator 79 of the advice providing server 4, and is connected to the advice providing server 4 in such a manner as to transmit and receive various pieces of data to and from the advice providing server 4 through the communication 3. Moreover, the communicator 25 may be a wired communication adapter, in which case the communication 3 is connected through a cable or the like. Furthermore, the communicator 25 has a protocol that is common between the communicator 25 and a communicator 95 of the advice providing apparatus 8, and may be configured in such a manner that transmission and reception of pieces of data are possible between the terminal device 2 and the advice providing apparatus 8. Moreover, the communicator 25 is equivalent to a terminal communicator.

The controller 27 is a control device or an arithmetic operation device that is configured to have a processor, such as a central processing unit (CPU) or a digital signal processor (DSP) , a storage device, such as a read-only memory (ROM), a flash ROM, or a random access memory (RAM), and the like, and that generally controls each unit of the terminal device 2 according to various programs that are stored in the storage device.

### Configuration of the Advice Providing Server

The advice providing server 4 is configured from database servers, such as a subject information management unit 30, an exercise data management unit 40, and an advice management unit 60, and the communicator 79. Furthermore, these servers and the communicator 79 are connected through the network 78.

The communicator 79 is configured from multiple communication adapters, such as a local area network (LAN) adapter, a wireless LAN adapter, and a short-distance wireless adapter, has a communication protocol that is common between each server within the advice providing server 4, and is common to the terminal device 2 and the advice providing apparatus 8, and is connected in such a manner as to communicate various pieces of data between the server, the apparatus, and the device.

Moreover, the communicator 79 is equivalent to a server communicator.

The subject information management unit 30 is configured from a processor 31 including a CPU and a database engine such as a relational database, a storage unit 33 including a data storage area of a database, and the like. The database engine has a basic function of managing a database, and under the control of the CPU, performs processing, such as registration of data in the database, data update, data deletion, or data retrieval, and transaction processing.

The storage unit 33 is configured as a storage device, such as a ROM, a flash ROM, a RAM, a hard disk drive (HDD), or a solid state drive (SDD). The subject information DB 35 that is managed in a table format is arranged in the storage unit 33. The specific information of the subject P is stored in the subject information DB 35.

The processor 31 is configured to include a functional unit (an illustration of which is omitted). A program (an illustration of which is omitted) in which a procedure for controlling each processing operation of the database engine, arithmetic operation processing, or the like is described is performed by the CPU, and thus a function of the functional unit is realized.

In order to enable the subject P to be recognized in the entire advice providing system 1, the functional unit of the processor 31 allocates a user ID (UID) to the subject P. In the advice providing system 1, the subject P is identified using the UID. The UID is equivalent to an identification number. Pieces of information, such as the UID, a full name, a gender, a birth date, an exercise purpose, job information, and disease information, are stored, as pieces of specific information of the subject P, in the subject information DB 35. Moreover, the specific information is one example. In addition to this, information, such as a height or a weight at the time of the start of the exercise program, an address, or a district may be included.

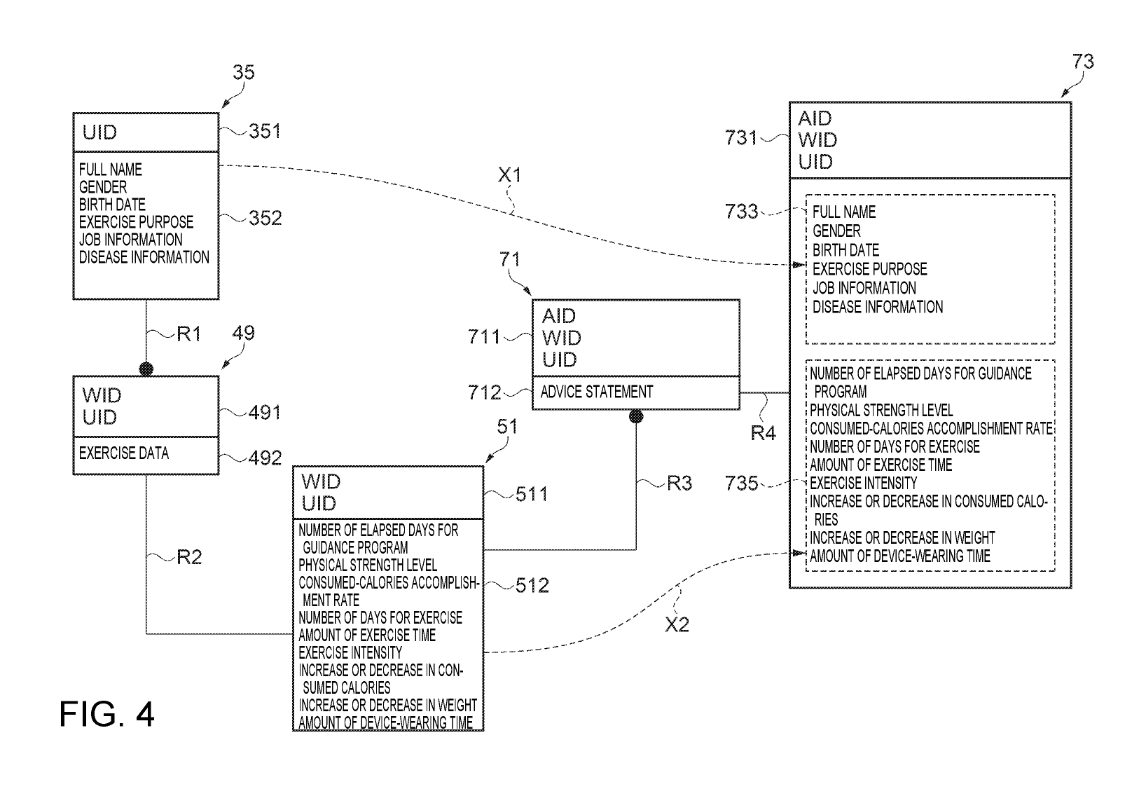

Moreover, a configuration example of a table that is managed in the subject information DB 35 and a link to a different table will be described below referring to FIG. 4.

The exercise data management unit 40 is configured from a processor 41 including a CPU and a database engine such as a relational database, a storage unit 47 including a data storage area of a database, and the like. The database engine has a basic function of managing a database, and under the control of the CPU, performs processing, such as registration of data in the database, data update, data deletion, or data retrieval, and transaction processing.

The processor 41 is configured to include functional units of an exercise data reception unit 43 and an analysis information generator 45. A program (an illustration of which is omitted) in which a procedure for controlling each processing operation of the database engine, arithmetic operation processing, or the like is described is performed by the CPU, and thus functions of these functional units are realized. Moreover, these functional units are one example and are not necessarily indispensable constituent elements. Other functional units may be included.

The exercise data reception unit 43 receives pieces of data relating to the exercise data and the exercise data from the terminal device 2 through the communicator 79, and stores the received pieces of data in the exercise data DB 49.

The analysis information generator 45 acquires the specific information of the subject P from the subject information management unit 30, and the exercise data during a predetermined period of time from the exercise data reception unit 43, and calculates the analysis information. The calculated analysis information is stored in the analysis information DB 51. Included in the analysis information are the number of elapsed days for a guidance program, a physical strength level, a consumed-calories accomplishment rate, the number of days for exercise, an amount of exercise time, an amount of zone-staying time in every pulse rate band, the exercise intensity, an increase or decrease in consumed calories, the amount of device-wearing time, and the like. Furthermore, a tendency for the weight to change, a tendency for a body mass index (BMI) to change, and the like that are calculated from the physical information that is collected from a different apparatus may be included in the analysis information. These pieces of analysis information are calculated with a known method, and are calculated by adding up or averaging various pieces of exercise data during a predetermined period of time that are detected and collected in the detector 20 under the control of the controller 27 of the terminal device 2, or by applying each arithmetic expression. Furthermore, the environmental information and information to which the environmental information is added may be included in the analysis information.

The number of elapsed days for the guidance program is the number of days that have elapsed from when the subject P started the exercise program.

The physical strength level is an index that is expressed in five levels by integrating a cardiorespiratory functional capacity, a muscular strength, an athletic ability, and the like of the subject P, and is calculated by comparing the exercise data acquired from the subject P with a reference value of the pulse rate that indicates the physical strength level in each level of the exercise intensity. Moreover, the calculation of the physical strength level of the subject P is one example. Any calculation method in which the index that indicates at what level the physical strength of the subject P is can be defined and calculated may be used.

The consumed-calories accomplishment is a numerical value (%) that is calculated as a rate of an accomplished consumed calories to a target consumed calories (100%) in the exercise data during a predetermined period of time.

The number of days for exercise is the number of days on which the exercise took place for a predetermined time (for example, two hours) or greater per day.

The amount of exercise time is an amount of time that is obtained by adding up amounts of time took for the exercise in the exercise data for a predetermined time.

The amount of zone-staying time for every pulse rate range is an amount of time that is obtained by adding up the pulse rates in a predetermined band, which change with an exercise load. For example, as the predetermined band, there are a pulse rate band that indicates fat burning, a pulse rate band that indicates an increase in muscular strength, and the like.

The exercise intensity is an average value of the exercise intensity in the exercise data during a predetermined period of time, and the unit for the exercise intensity is METS.

The increase or decrease in consumed calories is information that indicates as “increase” or “decrease” a result of acquiring exercise data information during a predetermined period of time in the past that is earlier than a current period of time and checking whether the consumed calories increase or decrease, against the consumed calories during the predetermined period of time in the past.

The tendency for the weight to change and the tendency for the BMI to change are pieces of information that indicate as “increase” or “decrease” a result of acquiring the exercise data information during the predetermined period of time in the past that is earlier than the current period of time and checking whether the weight and the BMI increase or decrease, against the weight and the BMI during the predetermined period of time in the past.

The amount of device-wearing time is the time for which the subject P wears the terminal device 2 during the predetermined period of time.

The storage unit 47 is configured as a storage device, such as a ROM, a flash ROM, a RAM, an HDD, or an SDD. The exercise data DB 49 and the analysis information DB 51 that are managed in a table format are arranged in the storage unit 47. The exercise data that is acquired from the terminal device 2 is stored in the exercise data DB 49 for every subject P. The analysis information that is calculated based on the exercise data which is stored in the exercise data DB 49 is stored in the analysis information DB 51 in a state of being associated with the exercise data.

Moreover, a configuration example of a table that is managed in the exercise data DB 49 and the analysis information DB 51 and a link to a different table will be described below referring to FIG. 4.

The advice management unit 60 is configured from a processor 61 including a CPU and a database engine such as a relational database, a storage unit 69 including a data storage area of a database, and the like. The database engine has a basic function of managing a database, and under the control of the CPU, performs processing, such as registration of data in the database, data update, data deletion, or data retrieval, and transaction processing.

The processor 61 is configured to include functional units of an advice retrieval unit 63, an advice registration unit 65, and an advice transmission unit 67. A program (an illustration of which is omitted) in which a procedure for controlling each processing operation of the database engine, arithmetic operation processing, or the like is described is performed by the CPU, and thus functions of these functional units are realized. Moreover, these operational units are one example and are not necessarily indispensable constituent elements. Other functional units may be included.

The advice retrieval unit 63 inputs the specific information of the subject P and the analysis information, and outputs a candidate (advice candidate) for the advice statement that relates to the specific information and the analysis information from the advice DB 71. More specifically, when the command c40 to request the advice candidate is received from the advice providing apparatus 8, the advice statement that is consistent with contents of retrieval items for the specific information and the analysis information that are designated as arguments of the command c 40 is retrieved from the advice DB 71. In the retrieval processing, the retrieval is performed at a high speed using the retrieval information DB 73. The retrieved advice statement is output as the advice candidate and is transmitted to the advice providing apparatus 8. In a case where the advice candidate is not present, a response indicating that the advice candidate is not present is transmitted to the advice providing apparatus 8.

The advice registration unit 65 registers the advice statement (the provision advice 71c) that is newly created by the advice providing apparatus 8, in the advice DB 71 in a state of being associated with the specific information of the subject P and the analysis information. More specifically, when the command c50 to register the advice is received from the advice providing apparatus 8 through the communicator 79, the provision advice 71c is stored in the advice DB 71 in a state of being associated with the specific information and the analysis information. Moreover, at this time, a configuration may be employed in which, in a case where the advice statement in the provision advice 71c is compared with other advice statements that are stored or advice candidates that have been transmitted and where there is similarity in the result, the advice statement in the provision advice 71c is not stored (registered), and, in a case where there is no similarity, the advice statement in the provision advice 71c is stored. When it comes to the determination of whether or not the similarity is present, in a case where a difference between comparison targets exceeds a predetermined amount, the comparison targets are determined as not being similar to each other. In a case where the difference is the same as the predetermined amount or does not exceed the predetermined amount, the comparison targets are determined as being similar to each other. For example, in a case where the predetermined amount is defined as a rate of the number of characters in a different portion to the number of characters in the advice statement and a value of the predetermined amount is defined as 5%, if the number of characters in the different portion is equal to or smaller than 5% of the number of total characters in the advice statement, the comparison targets are determined as being similar to each other. If the number of characters in difference exceeds 5%, the comparison targets are determined not as being similar to each other.

The advice transmission unit 67 transmits the provision advice 71c that is provided to the subject P, to the terminal device 2 through the communicator 79. More specifically, when the command c60 that instructs the terminal device 2 to transmit the provision advice 71c, and the provision advice 71c, from the advice providing apparatus 8 through the communicator 79, the provision advice 71c is transmitted to the terminal device 2. In the terminal device 2, when the provision advice 71c is received, the provision advice 71c is displayed on the display unit 21.

The storage unit 69 is configured as a storage device, such as a ROM, a flash ROM, a RAM, an HDD, or an SDD. The advice DB 71 and the retrieval information DB 73 that are managed in a table format are arranged in the storage unit 69.

The provision advice 71c that is transmitted from the advice providing apparatus 8 is stored in the advice DB 71 in a state of being associated with the specific information of the subject P and the analysis information. Moreover, the advice registration unit 65 and the advice DB 71 are equivalent to an advice storage unit.

The retrieval information DB 73 is a table that is designed in such a manner that the provision advice 71c associated with a retrieval key is able to be retrieved at a high speed from a group of the pieces of provision advice 71c that are stored in the advice DB 71 with a designated item for the specific information and the analysis information as the retrieval key. A result of the retrieval is output as the advice candidate. Moreover, the advice retrieval unit 63 and the retrieval information DB 73 are equivalent to an advice retrieval unit.

Moreover, a configuration example of a table that is managed in the advice DB 71 and the retrieval information DB 73 and a link to a different table will be described below referring to FIG. 4.

### Configuration of the Advice Providing Server/the Database Table

FIG. 4 is an entity-relationship diagram illustrating a relationship with a database table of the advice providing server 4. Moreover, a description will be described below on the assumption that each database is configured as a relational database.

A main key 351 of the subject information DB 35 is the UID. A record 352 is an area in which the specific information is stored. Pieces of information, such as a full name, a gender, a birth date, an exercise purpose, job information, and disease information are stored in the record 352.

A main key 491 of the exercise data DB 49 is a complex type and is configured from a workout ID (WID) and the UID. The exercise data is stored in the record 492. An entity of the exercise data is stored in a different storage area, and a link address to the entity is stored in a record 492.

A main key 511 of the analysis information DB 51 is a complex type, and is configured from the WID and the UID. A record 512 is an area in which the analysis information is stored. Included in the record 512 are pieces of information, such as the number of elapsed days for a guidance program, a physical strength level, a consumed-calories accomplishment rate, the number of days for exercise, an amount of exercise time, the exercise intensity, an increase or decrease in consumed calories, an increase or decrease in weight, and an amount of device-wearing time.

A main key 711 of the advice DB 71 is a complex type, and is configured from an advice ID (AID), the WID, and the UID. The advice statement is stored in a record 712. A configuration may be employed in which an entity of the advice statement is stored in a different storage area, and in which a link address to the entity is stored in the record 712. Moreover, the advice statement that is managed in the advice DB 71 is a statement of the provision advice 71c.

A main key 731 of the retrieval information DB 73 is a complex type and is configured from the AID, the WID, and the UID. A replica X1 of the record 352 is set for a record 733, and a replica X2 of the record 512 is set for a record 735. In a case where arbitrary pieces of data in the record 733 and the record 735 are designated, the retrieval information DB 73 may be configured in such a manner that the AID, the WID, and the UID that are consistent with these pieces of data can be retrieved at a high speed, and may be configured in such a manner that instead of the replica X1 or the replica X2, a pointer (address reference) is used. Furthermore, a method may be employed in which high-speed retrieval is realized by using an index function that is a general function of the database engine and referring to physical addresses of the record 352 and the record 512 without establishing the retrieval information DB 73.

The subject information DB 35 and the exercise data DB 49 have a relationship that is a relationship R1. The relationship R1 indicates a one-to-many relationship (many is indicated by a black circle), and indicates that multiple pieces of exercise data are present for the UID of the subject information DB 35. For example, if the period of time for the exercise program for the subject P is half a year and a predetermined period of time during which the exercise data is analyzed and the advice is provided is one month, for the WID, pieces of exercise data for 6 months from 001 to 006 are stored.

A relationship R2 is a one-to-one relationship. One set of pieces of analysis information (the record 512) is present for one piece of exercise data (the record 492). Moreover, the exercise data DB 49 and the analysis information DB 51 may be linked to one table.

A relationship R3 is a one-to-many relationship, and indicates a configuration in which multiple advice statements (the record 712) are able to be present for one piece of analysis information (the record 512) or for one piece of exercise data (the record 492). In a case where multiple advice statements (the provision advice) that are provided to the subject P are created, multiple advice statements are stored for the same exercise data.

A relationship R4 is the one-to-one relationship, and has a configuration in which the record 733 and the record 735 for retrieval are stored in each of the advice statements that are stored.

With this relationship in terms of the configuration of the database, it is possible to designate items for the specific information (the record 352) and the analysis information (the record 512) that are stored in the retrieval information DB 73 and to retrieve the advice statement (the record 712) that is consistent with contents of the items.

### Configuration of the Advice Providing Apparatus

A description of the advice providing apparatus 8 is provided referring back to FIG. 3.

The advice providing apparatus 8 is configured from the display unit 91, the operation unit 93, the communicator 95, a storage unit 97, a controller 80, and the like.

The display unit 91 is a display device that is configured to have a display panel, such as a general purpose liquid crystal display (LCD), and that performs various display operations based on a display signal that is output from the controller 80 (a display controller 83).

The operation unit 93 is an input device that is configured to have a button switch, a touch panel, or the like, and that outputs a signal of the button or the touch panel that is pushed down, to the controller 80.

As a suitable example, the communicator 95 is a wireless LAN adapter, has the communication protocol that is common between the communicator 95 and the communicator 79 of the advice providing server 4, and is connected to the advice providing server 4 in such a manner as to transmit and receive various pieces of data to and from the advice providing server 4 through the communication 5. Moreover, the communicator 95 may be a wired communication adapter, in which case, the communication 5 is connected through a cable or the like. Furthermore, the communicator 95 has a protocol that is common between the communicator 95 and the communicator 25 of the terminal device 2, and may be configured in such a manner that the transmission and reception of pieces of data are possible between the advice providing apparatus 8 and the terminal device 2. With this configuration, the determined advice statement (the provision device 71c) can be transmitted directly from the advice providing apparatus 8 to the terminal device 2 without involving the advice providing server 4.

Moreover, the communicator 95 is equivalent to a provision apparatus communicator.

The storage unit 97 is configured as a storage device, such as a ROM, a flash ROM, a RAM, an HDD, or an SSD. Various programs, pieces of data, and the like for realizing each functional unit of the controller 80 are stored in the storage unit 97.

The controller 80 is a control device or an arithmetic operation device that is configured to have a processor, such as a CPU or a DSP, a storage device, such as a ROM, a flash ROM, or a RAM, and the like, and that generally controls each unit of the advice providing apparatus 8 according to various programs that are stored in the storage device.

The controller 80 is configured to include functional units of a collector 81, the display controller 83, a retrieval requester 85, the editing unit 87, and a determiner 89. Moreover, these operational units are one example and are not necessarily indispensable constituent elements. Other functional units may be included.

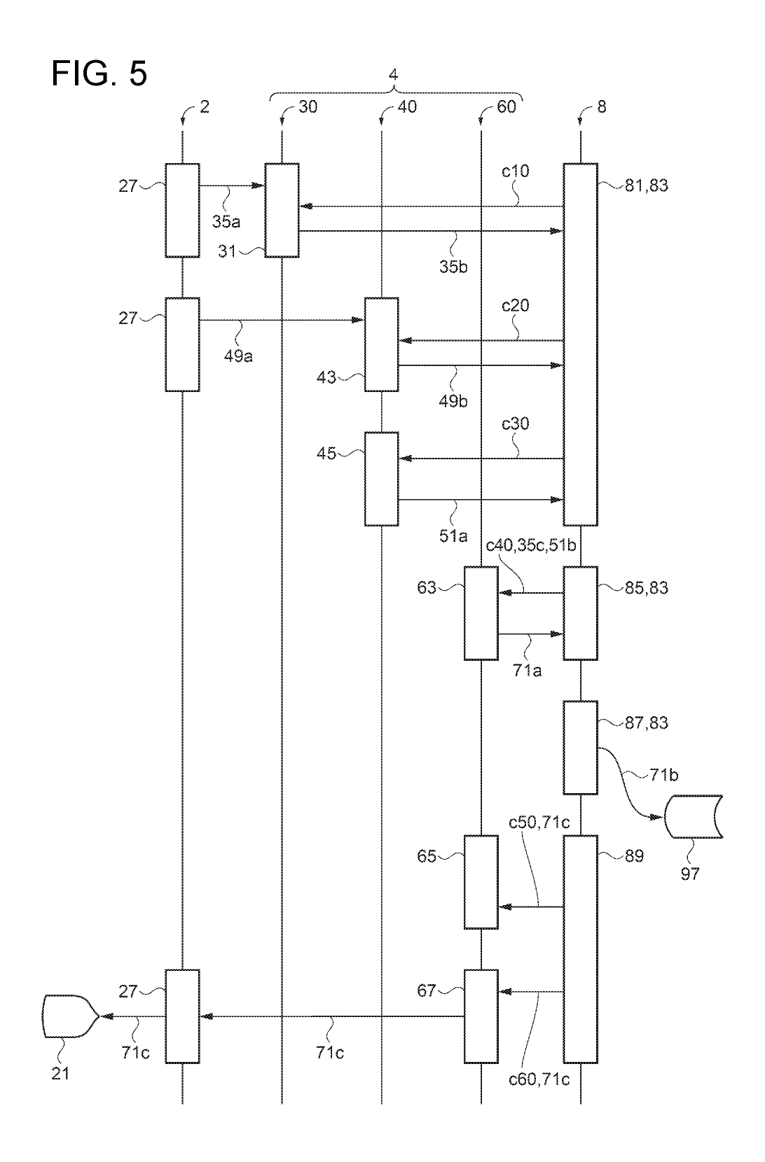

The collector 81 collects the specific information of the subject P, the exercise data, the analysis information, and the like. More specifically, information (a name or the like) that specifies the subject P and that is input by the mentor M through the operation unit 93 is input. The information that specifies the subject P and commands c10, c20, and c30 (which will be described below referring to FIG. 5) that request the transmission of the specific information, the exercise data, and the analysis information are transmitted to the advice providing server 4 side. A response from the advice providing server 4 is awaited, and the specific information, the exercise data, and the analysis information are collected and stored in the storage unit 97.

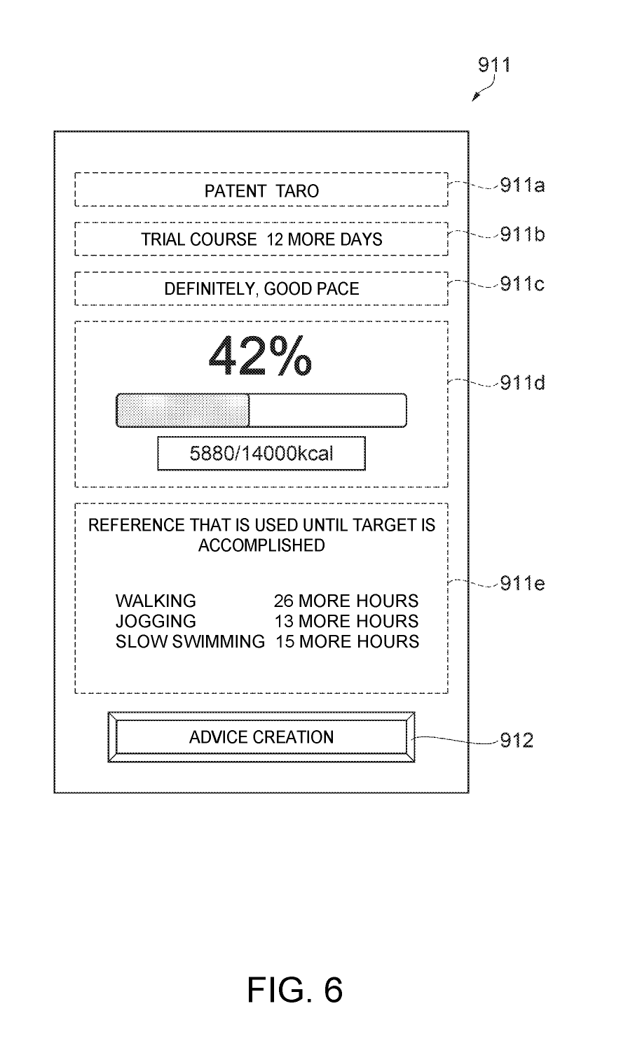

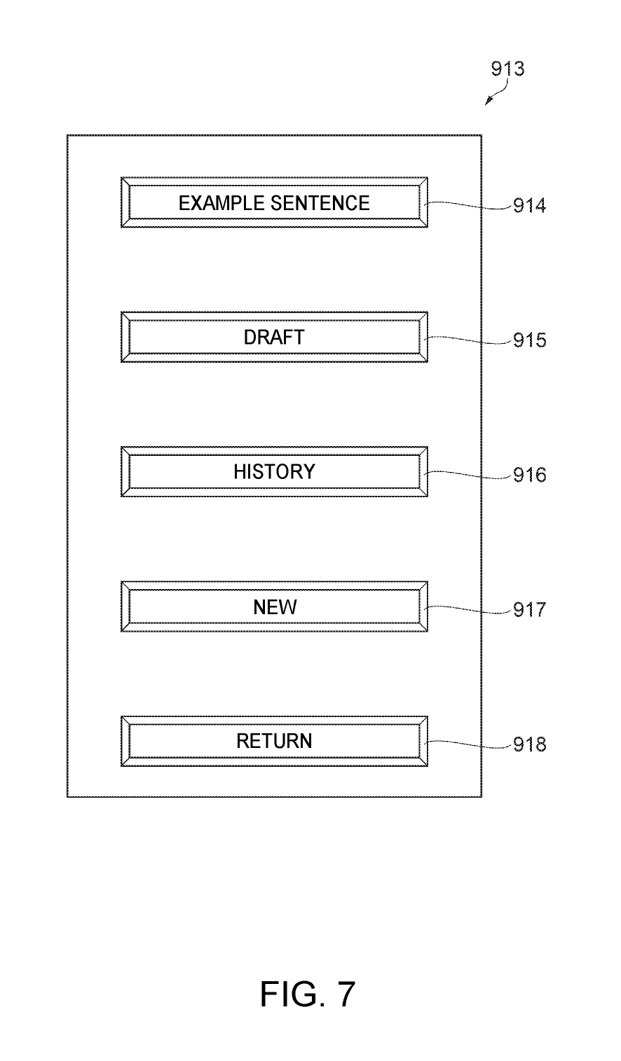

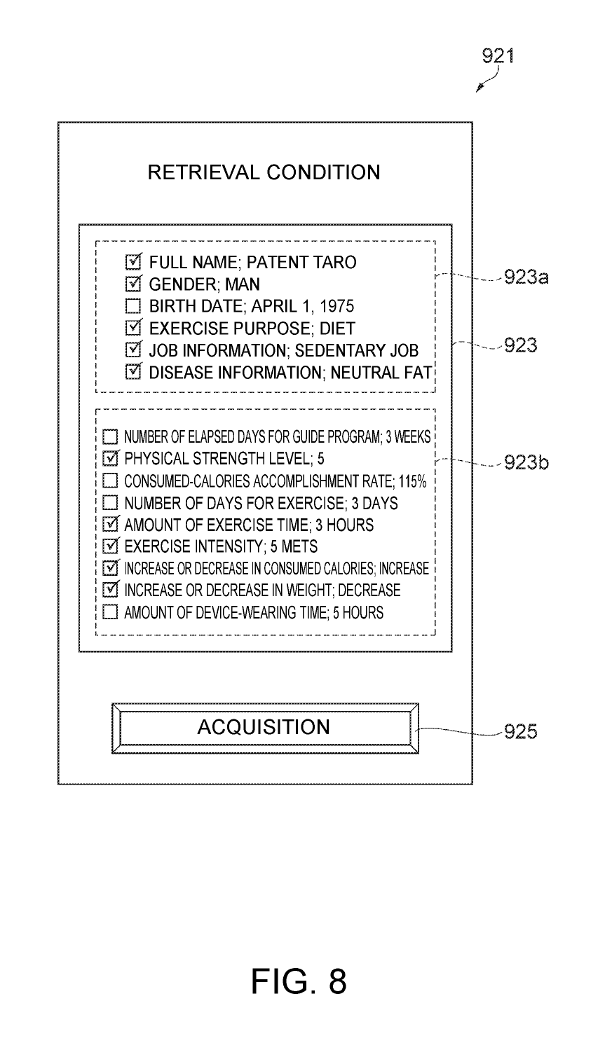

The display controller 83 sets event processing that corresponds to each operation by controlling the operation unit 93, generates various display screens in accordance with a type of event, and outputs the generated screen to the display unit 91. Specifically, display screens are generated that are displayed on a subject information display screen 911 (FIG. 6), a creation instruction screen 913 (FIG. 7), a retrieval instruction screen 921 (FIG. 8), the advice candidate display screen 927 (FIG. 9), the advice editing screen 939 (FIG. 10), and the like. The event processing that corresponds to a button push (touch on the touch panel) that is included in these screens, the event processing relating to operation at the time of the text editing, or the like is defined. When the generated screen and the event processing are output to the display unit 91, the event processing that corresponds to each operation is set at the same time.

Moreover, the display controller 83 that displays the advice candidate display screen 927 is equivalent to an advice candidate display unit.

The retrieval requester 85 requests the advice providing server 4 to retrieve the advice candidate, and acquires the advice candidate. More specifically, the retrieval instruction screen 921 is displayed by the display controller 83. In the retrieval instruction screen 921, it is possible to select a retrieval designation item. In the retrieval instruction screen 921, when an (acquisition) button 925 is touched on, the retrieval requester 85 operates. The retrieval requester 85 transmits the command c40 to request the advice candidate, the selected retrieval designation item, and a value (contents) thereof, to the advice providing server 4, and waits for a response.

When the advice candidate is received from the advice providing server 4, the control is transferred to the display controller 83, and the advice candidate display screen 927 is displayed.

In the editing unit 87, the advice statement that is an editing target is selected from the advice candidates, and it is possible to edit the selected advice statement. More specifically, when the advice statement that is selected as the editing target is selected from the advice candidate display screen 927, the selected advice statement is displayed on the advice editing screen 939. Because the advice statement is editable, the mentor M can create a new advice statement based on the advice statement. The advice statement in a state of being editable is equivalent to the edit advice.

In the determiner 89, the editing of the advice statement (the edit advice) is finished, and processing in a case where the advice statement is provided to the subject P is performed. More specifically, when a (transmission) button 949 on the advice editing screen 939 is touched on, the determiner 89 operates. The determiner 89 transmits the command c50 (FIG. 5) to instruct the advice providing server 4 to store the advice statement in the advice DB 71, and the command c60 (FIG. 5) to instruct the terminal device 2 to transmit the advice statement.

On the advice providing server 4 side, the advice registration unit 65 performs registration processing in response to the command c50 to indicate that the registration has to be performed, and processing for the transmission to the terminal device 2 side is performed by the advice transmission unit 67 in response to the command c60 to indicate that the transmission has to be performed.

### Sequence of the Advice Providing System

Next, exchange of information between the terminal device 2, the advice providing server 4, and the advice providing apparatus 8 and processing for each process are described in time series referring to FIG. 5. Moreover, this sequence of processing is equivalent to a method of providing advice.

FIG. 5 is a sequence diagram illustrating a schematic sequence for the advice providing system. In the present sequence diagram, processing operations up to and including a processing operation in which the functional units in the terminal device 2, the advice providing server 4 (the subject information management unit 30, the exercise data management unit 40, and the advice management unit 60), and the advice providing apparatus 8 cooperate with one another to provide the advice statement to the subject P are illustrated with the passage of time (from top to bottom in FIG. 5).

The controller 27 of the terminal device 2 transmits specific information 35a of the subject P to the subject information management unit 30.

The collector 81 and the display controller 83 of the advice providing apparatus 8 transmit the command c10 to request the specific information of the subject P to the subject information management unit 30.

When the command c10 is received from the advice providing apparatus 8, the processor 31 of the subject information management unit 30 retrieves the specific information of the subject P from the stored subject information DB 35, extracts necessary information from pieces of specific information, and transmits (in response) the extracted necessary information as specific information 35b to the advice providing apparatus 8.

The controller 27 of the terminal device 2 transmits the exercise data 49a to the exercise data management unit 40. The exercise data 49a may be partially transmitted multiple times during a predetermined period of time. For example, the exercise data 49a for the day may be collected, and transmitted every day, or may be transmitted every hour. Furthermore, a configuration may be employed in such a manner that a period of time from when the subject P begins to take exercise to when the subject P finishes taking exercise is defined as one unit and the transmission is performed.

The exercise data reception unit 43 of the exercise data management unit 40 receives the exercise data 49a and stores the received exercise data 49a in the exercise data DB 49. Pieces of exercise data 49a are accumulated during a predetermined period of time.

When the predetermined period of time has elapsed, the collector 81 and the display controller 83 of the advice providing apparatus 8 transmit the command c20 to request the exercise data of the subject P, to the exercise data management unit 40.

When the command c20 is received from the advice providing apparatus 8, the exercise data reception unit 43 of the exercise data management unit 40 collects the pieces of exercise data 49b that are accumulated during the predetermined period of time and transmits (in response) the collected pieces of exercise data 49a to the advice providing apparatus 8.

The collector 81 and the display controller 83 of the advice providing apparatus 8 transmit the command c30 to request the analysis information of the subject P that is available after the predetermined period of time has elapsed, to the exercise data management unit 40.

When the command c30 is received from the advice providing apparatus 8, the analysis information generator 45 of the exercise data management unit 40 generates the analysis information from data that belongs to the exercise data 49b during a predetermined period of time. The generated analysis information is transmitted (in response) as analysis information 51a to the advice providing apparatus 8. Moreover, a configuration is employed in which, when the command c30 is received from the advice providing apparatus 8, the analysis information is generated from the data that belongs to the exercise data 49b during the predetermined period of time, but a configuration may be employed in which, if the exercise data 49a is received, without the need for the command, the exercise data is analyzed and the analysis information is generated. With this configuration, responsiveness relating to the provision of the analysis information can be improved.

The collector 81 and the display controller 83 of the advice providing apparatus 8 receive the specific information 35b, the exercise data 49b, and the analysis information 51a in response to the commands c10, c20, and c30. Furthermore, pieces of information that are the UID of the subject P and the WID of a target exercise data which are managed in a database of the advice providing server 4 are also included in these pieces of information.

Moreover, a configuration may be employed in which, after the command c20 is received, the exercise data reception unit 43 of the exercise data management unit 40 collects the exercise data 49b, transfers the processing to the analysis information generator 45, generates the analysis information 51a, puts together the exercise data 49b and the analysis information 51a and transmits the put-together exercise data 49b and analysis information 51a to the advice providing apparatus 8. With this configuration, because there is no need to transmit the command c30 from the advice providing apparatus 8, the responsiveness relating to the provision of the analysis information can be improved.

Furthermore, a configuration may be employed in which, after the exercise data 49a during a predetermined period of time is received from the terminal device 2, without the need for the command, such as the command c20 and the command c30, the exercise data reception unit 43 of the exercise data management unit 40 analyzes the exercise data 49a and transmits the exercise data 49b and the analysis information 51a to the advice providing apparatus 8. With this configuration, in the advice providing apparatus 8, it can be determined that a timing at which the exercise data 49b and the analysis information 51a are received is a timing at which measurement of the exercise data 49a during the predetermined period of time is finished by the subject P. A timing at which the exercise during a predetermined period of time for the subject P is finished is considered as a good opportunity to provide the advice to the subject P, proceeding to processing that will be described below takes place, and thus the advice statement can be provided to the subject P.

The retrieval requester 85 and the display controller 83 of the advice providing apparatus 8 display contents of the specific information 35b and the analysis information 51a (the retrieval instruction screen 921) and transmit a retrieval item 35c for the specific information and a retrieval item 51b for the analysis information, which are selected, and the command c40 to request the advice candidate, to the advice providing server 4.

The advice retrieval unit 63 of the advice providing server 4 retrieves the advice statement containing the specific information and the analysis information that are consistent with the retrieval item 35c and the retrieval item 51b, using the retrieval information DB 73. The advice statement (the advice candidate) that is retrieved from the advice DB 71 is acquired and transmitted (in response) as the advice candidate 71a to the advice providing apparatus 8. Moreover, the present processing is equivalent to an advice retrieval process.

Next, the editing unit 87 and the display controller 83 of the advice providing apparatus 8 display the received advice candidate 71a (the advice candidate display screen 927), and displays a screen (the advice editing screen 939) on which the selected advice statement is edited. An edit advice 71b that results from the editing in progress is stored at any time in the storage unit 97.

When the editing for the edit advice 71b is finished and the advice statement (the provision advice 71c) that is to be provided to the subject P is determined, the determiner 89 of the advice providing apparatus 8 transmits the command c50 to indicate that the provision advice 71c has to be registered and the provision advice 71c to the advice providing server 4. Moreover, the present processing is equivalent to a determination process.

When the command c50 is received, the advice registration unit 65 of the advice providing server 4 stores (registers) the provision advice 71c in the advice DB 71. At this time, the advice registration unit 65 registers the provision advice 71c in the advice DB 71, in a case where contents of the advice candidate 71a that is transmitted by the advice retrieval unit 63 and contents of the provision advice 71c are compared with each other and it is determined that a different exceeds a predetermined amount and that no similarity is present, that is, in a case where a predetermined registration condition is satisfied. At the time of the registration, a new AID is numbered and is registered in the UID of the subject P and the WID of the target exercise data. The AID, the UID, and the WID are registered in a set, and thus the provision advice 71c is stored in the advice DB 71, in a state where the specific information and the analysis information are associated with the provision advice 71c. Moreover, the present processing is equivalent to an advice storage process.

The determiner 89 of the advice providing apparatus 8 transmits the command c60 to instruct the terminal device 2 to transmit the provision advice 71c and the provision advice 71c to the advice providing server 4. The advice transmission unit 67 on the advice providing server 4 side transmits the provision advice 71c to the terminal device 2.

When the provision advice 71c is received, the controller 27 of the terminal device 2 outputs the provision advice 71c to the display unit 21. In this manner, the provision advice 71c is displayed on the display unit 21 of the terminal device 2, and the subject P can visually recognize the advice information that is edited by the mentor M.

### Example of a Display Screen on the Advice Providing Apparatus

Next, an example of a display screen that is displayed on the display unit 91 of the advice providing apparatus 8 is described referring to FIGS. 6 to 10. These display screens are screens that, under the control of the display controller 83, are displayed on the display unit 91, and are visually recognized mainly by the mentor M. Furthermore, the display screen is covered with a touch panel. When operation is performed in an area (a button or the like) on a screen that corresponds to an operation area of the touch panel, operation of each function unit, switching between the display screens, or the like is performed by the controller 80.

FIG. 6 is a diagram illustrating one example of a subject information display screen.

The subject information display screen 911 is configured to have display areas 911a to 911e and a button 912. Pieces of subject information that are displayed on the subject information display screen 911 include the specific information of the subject P, the exercise data, the analysis information, and information that is processed using these pieces of information.

The display area 911a is an area on which the name of the subject P is displayed, and “Patent Taro” is displayed. The display area 911b is an area on which the name of an exercise program or the like that is implemented by the subject P is displayed, and “Trial course 12 more days” is displayed. The display area 911c and the display area 911d are areas on which an exercise status of the subject P is displayed, and “Definitely, a good pace” which is a status of progress toward a target value is expressed as a rate or a numerical value. This is a sentence, a symbol, or the like that indicates the status of progress that is determined based on a rate of an accomplishment to an accomplishment target value during the period for the exercise program. In an example of the display area 911d, the accomplishment target value of 14000 kcal in terms of consumed calories during the period of time for the exercise program, a currently-achieved value of 5880 kcal, and an accomplishment rate of 42% are displayed with a bar graph. “Definitely, a good pace” that results from evaluation is a good performance because the rate of the accomplishment of consumed calories to the accomplishment target of the exercise program moves along smoothly in light of a progress schedule during the period of time for the exercise program. Moreover, the display area 911c and the display area 911d may be configured in such a manner that any one of the two areas is displayed.

The display area 911e is an area on which an amount of exercise is displayed until the target is accomplished. With these pieces of information, such as “Reference that is used until the target is accomplished”, “walking 26 more hours”, “jogging 13 more hours”, and “slow swimming 15 more hours”, a concrete exercise item is proposed and the time it takes to consume the remaining calories−8120 kcal (=14000 kcal−5880 kcal) is displayed.

The button 912 is an operation area for proceeding to processing that creates the advice statement, and “Advice creation” is displayed on the surface of the button. By touching on the button, the creation instruction screen 913 (FIG. 7) is displayed.

FIG. 7 is a diagram illustrating one example of a creation instruction screen.

The creation instruction screen 913 is a screen that is configured to have buttons 914 to 918 and that is selected for a method of creating the advice statement.

“Example sentence” is written on the button top of the button 914, and when the present button is touched on, a method of creating the advice statement referring to an example sentence is selected. When the button 914 is touched on, the retrieval instruction screen 921 (FIG. 8) is displayed.

“Draft” is written on a button top of the button 915, and when the present button is touched on, a method in which the advice statement that is retained while being edited is acquired and the advice statement is created is selected. More specifically, the retained advice statement can be read and edited by touching on a button 947 (retention) on the advice editing screen 939 (FIG. 10).

“History” is written on the button top of the button 916, and when the present button is touched on, a method in which the advice statement is created referring to the advice statement that was created by the mentor M in the past is selected. More specifically, because the advice statement that is already provided by the mentor M to multiple subjects is stored in the storage unit 97, these advice statements are read and edited.

“New” is written on the button top of the button 917, and when the present button is touched on, a method of newly creating the advice statement is selected.

“Return” is written on the button top of the button 918, and when the present button is touched on, the subject information display screen 911 is displayed.

FIG. 8 is a diagram illustrating one example of the retrieval instruction screen.

The retrieval instruction screen 921 is a screen that is configured to have a display area 923 and the button 925 and on which a retrieval condition is selected when the example sentence for the advice statement is retrieved.

The display area 923 has a specific information display area 923a and an analysis information display area 923b.

A check box, an item for the specific information, and contents of the specific information are described on the specific information display area 923a for every row. In a case where the check box is checked, an item for a target specific information is set to be a retrieval target, and in a case where the check box is not checked, the item of the target specific information is set not to be the retrieval target. In the specific information display area 923a, “Full name”=“Patent Taro”, “Gender”=“Man”, “Exercise purpose”=“Diet”, “Job information”=“Sedentary job”, and “Disease information”=“Neutral fat” are selected as retrieval targets, and “Birth date”=“Apr. 1, 1975” is not selected.

A check box, an item for the analysis information, and contents of the analysis information are described on the analysis information display area 923b for every row. In a case where the check box is checked, an item for target analysis information is set to be a retrieval target, and in a case where the check box is not checked, the item of the target analysis information is set not to be the retrieval target. In the analysis information display area 923b, “Physical strength level:=“5”, “Amount of exercise time”=“3 hours”, “Exercise intensity”=“5 METS”, “Increase or decrease in consumed calories”=“Increase”, and “Increase or decrease in weight=“Decrease” are selected as retrieval targets. Furthermore, “The number of elapsed days for a guidance program”=“3 weeks”, “Consumed-calories accomplishment rate”=“115%”, “The number of days for exercise”“3 days”, and “an amount of device-waring time”=“5 hours” are not selected as retrieval targets.

“Acquisition” is written on the button top of the button 925, and when the present button is touched on, the advice statement that is consistent with contents of an item which is selected as the retrieval condition is acquired. When the advice statement is acquired, the advice candidate display screen 927 is displayed.

FIG. 9 is a diagram illustrating one example of the advice candidate display screen.

The advice candidate display screen 927 is configured to have a button 929 and display areas 931, 933, 935, and 937, and on which the acquired advice statement is displayed as the advice candidate. When one of the display areas 931 to 937 is touched on, proceeding to the advice editing screen 939 (FIG. 10) for editing the advice statement that is displayed at a position of the touched-on display area takes place.

“Retrieval condition” is written on the button top of the button 929. When the present button is touched on, proceeding to the retrieval instruction screen 921 takes place, and it is possible to change the retrieval condition.

The advice candidates that are retrieved and acquired are displayed on the display areas 931, 933, 935, and 937, respectively. Here, four advice candidates are displayed. When each of the display areas 931 to 937 is touched on, the advice statement on the selected display area is selected as the editing target and proceeding to the advice editing screen 939 (FIG. 10) takes place.

Moreover, in a case where the number of acquired advice candidates is further great, the display area size of each of the display areas 931 to 937 can be reduced and thus many of the advice candidates can be displayed in the form of a list. Furthermore, in order to further select many of the advice candidates, a button for display on the next page or the like can be provided or a scroll bar can be provided, and thus the advice candidate that is not displayed on the screen can be displayed by scrolling. Additionally, the number of advice candidates to be displayed can be designated and the advice candidates up to the designated numbers can be displayed.

FIG. 10 is a diagram illustrating one example of the advice editing screen.

The advice editing screen 939 is a screen that is configured to have an editing area 941, an editing operation area 943, and buttons 945, 947, and 949 and on which the advice statement for the selected advice candidate is edited.

The editing area 941 is an area on which the advice statement for editing is displayed and on which an editing job, such as inserting, deleting, or changing a character, is possible at a position of a cursor 941a. The cursor 941a can be moved to an arbitrary position on the editing area 941.

The editing operation area 943 has a function of making it possible to perform switching between conversion, insertion, deletion, change, and the like of types of characters or various characters that are used to operate the editing on the editing area 941. The editing operation area 943 is equivalent to a keyboard in a general purpose PC.

“Return” is written on the button top of the button 945, and when the present button is touched on, the advice candidate display screen 927 is displayed.

“Retention” is written on the button top of the button 947, and when the present button is touched on, the advice statement that is displayed on the editing area 941 is stored in the storage unit 97.

“Transmission” is written on the button top of the button 949, and when the present button is touched on, the advice statement that is displayed on the editing area 941 is transmitted to the advice providing server 4, along with the command c50 to indicate that the advice has to be registered and the command c60 to indicate that the advice has to be transmitted. The advice providing server 4 stores (registers) the received advice statement in the advice DB 71, and transfers the received advice statement to the terminal device 2.

As described above, according to the advice providing system 1 according to the present embodiment, the following effects can be obtained.

The pieces of provision advice that are provided to the subject P are accumulated in the advice providing server (the advice management unit 60). In a case where new provision advice is newly created, the advice providing apparatus 8 designates the specific information and the analysis information and retrieves the advice candidate from the advice providing server 4. Accordingly, the advice providing apparatus 8 can acquire the advice candidate that is a reference for creating new provision advice. In the editing unit 87 of the advice providing apparatus 8, the advice candidate is referred to and the advice candidate is edited, and thus the provision advice that is provided to the subject P can be generated. Accordingly, the advice that is to be provided to the subject P can be edited using an expression that is different from that used in the advice candidate.

Additionally, in a case where a difference between the generated provision advice and the advice candidate referred to exceeds a predetermined amount, the generated provision advice is stored in the advice providing server 4. To be more precise, pieces of provision advice in various advice statements that have different contents are accumulated in the advice providing server 4.

Therefore, because new provision advice is created referring to various pieces of advice that are already provided to the subject P, the editing can be performed while avoiding a monotonous sentence expression, and the concern that the advice that gives the non-emotional impression that the advice is created mechanically is repeatedly provided to the subject P is reduced.

Furthermore, in the system, the pieces of provision advice that are provided to the subject P are accumulated in the advice providing server 4. Because of this, there is no need to create a large number of advice statements in advance. To be more precise, the system is easier to realize than an apparatus in the related art.

Additionally, in a case where a difference in contents between the provision advice and the advice candidate is small, because the registration in the advice storage unit is not performed, there is also an effect that suppresses an amount of advice information that is accumulated in the advice providing server 4.

In addition, the invention is not limited to the embodiments described above and can add various modifications or improvements to the embodiments described above. Modification example will be described below.

### First Modification Example

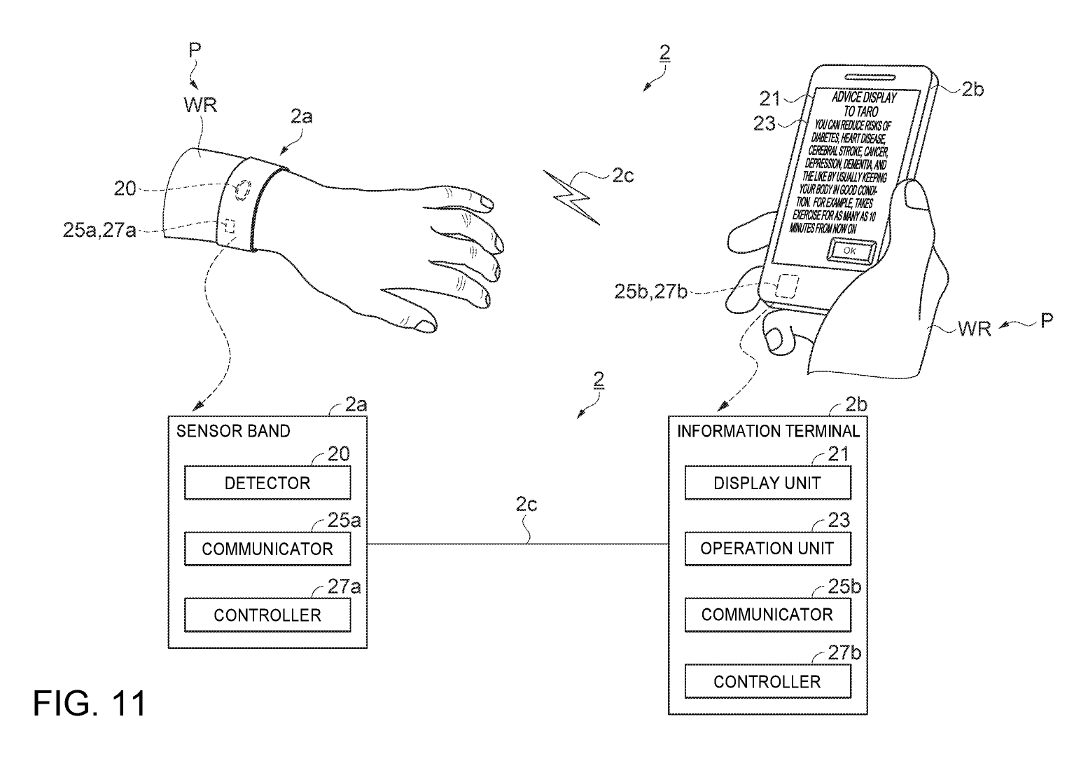

FIG. 11 is an explanatory diagram illustrating an outline of the terminal device according to a first modification example.

According to the embodiments described above, the terminal device 2 is described as the wristwatch-type terminal device including the detector 20 that detects the exercise data of the subject P, and the display unit 21 on which the advice information is displayed, but no limitation to this configuration is imposed. The terminal device 2 may be configured to include multiple devices, each of which includes a sensor band 2a including the detector 20, and an information terminal 2b including the display unit 21.

The terminal device 2 is configured from the sensor band 2a that is worn on the wrist WR of the subject P and the information terminal 2b that is used by the same subject P, and the sensor band 2a and the information terminal 2b are connected to each other in such a manner as to perform various types of data communication through communication 2c.

The sensor band 2a is configured from the detector 20, communicator 25a, and a controller 27a. The detector 20 detects the exercise data of the subject P. As a suitable example, the communicator 25a is a short-distance wireless adapter, establishes communication with a communicator 25b of the information terminal 2b through the communication 2c, and performs transmission and reception of various pieces of data including transmission of the exercise data. The controller 27a is a CPU or a DSP, and has a storage device, such as a ROM or a RAM.

Because the sensor band 2a is configured from a minimum number of elements for acquiring the exercise data from the subject P, the sensor band 2a is excellent in miniature, weight saving, and power-saving, and the exercise data of the subject P can be detected over a long period of time.

The information terminal 2b is a general purpose smartphone or tablet terminal, or PC, and is configured from the display unit 21, the operation unit 23, the communicator 25b, the controller 27b, and the like.

The display unit 21 is a display device that is configured to have a display panel, such as a general purpose high-resolution camera LCD, and on which the advice information that is transmitted from the advice providing server 4 is displayed.

The operation unit 23 is an input device that is configured to have a button switch, a touch panel, or the like.

As a suitable example, the communicator 25b is a wireless LAN adapter, establishes communication with the communicator 25a of the sensor band 2a through the communication 2c, and performs the transmission and reception of various pieces of data including the reception of the exercise data. Furthermore, the communicator 25b establishes communication with the communicator 79 of the advice providing server 4 and performs the transmission and reception of various pieces of data including the exercise data and the advice information through the communication 3. The controller 27b is a CPU or a DSP, and has a storage device, such as a ROM or a RAM.

According to the present modification example, the terminal device 2 can detect the exercise data of the subject P with the sensor band 2a over a long period of time, and can display the advice information for the subject P on a large-sized screen in a detailed manner with the information terminal 2b. Therefore, the terminal device 2 that the subject P can use in an easy manner and visually recognize the advice information in an easy-to-understand manner can be provided.

### Second Modification Example

A second modification example is described referring to FIGS. 7 to 9.

According to the embodiments and the modification examples, which are described above, when the button 914 (the example sentence) on the creation instruction screen 913 is selected, the retrieval instruction screen 921 is displayed, but no limitation to this configuration is imposed. A configuration may be employed in which, after the button 914 is selected, the advice candidate display screen 927 is displayed.

With this configuration, the advice candidate that is retrieved based on the retrieval item which is set in advance is displayed on the advice candidate display screen 927.

### Third Modification Example

According to the embodiments and the modification examples, which are described above, the provision advice is displayed on the display unit 21 of the terminal device 2. However, the information that is displayed is not limited to the provision advice, and the analysis information may be included. In this case, the inclusion of the analysis can be realized with a configuration in which the provision advice and the analysis information are also transmitted from the advice providing server 4. With this configuration, because the subject P can visually recognize the provision advice and the analysis information that supports the provision advice, the more persuasive information can be provided to the subject P.

### Fourth Modification Example

According to the embodiments and the modification examples, which are described above, the provision advice is displayed on the display unit 21 of the terminal device 2. However, no limitation to this configuration is imposed, and any configuration in which the contents of the provision advice are transferred to the subject P maybe possible. For example, a configuration may be employed in which a voice output unit is included and the provision advice is output in voice. Furthermore, a configuration may be employed in which the subject P can read the analysis information or the provision advice that is provided from the advice providing server 4, at a timing at which the analysis information or the provision advice is necessary, through a different PC that is network-connected.

### Fifth Modification Example

According to the embodiments and the modification examples, which are described above, that database engine that constitutes the advice providing server 4 is described with the relational database as an example. However, no limitation to this database engine is imposed, and management may be performed using a different database engine, such as an object-oriented database, or a program that results from programming using a high-level language.

What is claimed is:

1. An advice providing system comprising:
an advice storage device in which analysis information that results from analysis based on exercise data of a subject, specific information of the subject, and advice information that is provided to the subject are stored associated with one another;
an advice retrieval unit that retrieves at least one advice candidate from the pieces of advice information that are stored in the advice storage unit, based on at least one piece of information of the analysis information and the specific information; and
a determiner that determines edit advice that results from performing editing referring to the advice candidate, as provision advice that is provided to the subject.

2. The advice providing system according to claim 1,
wherein the provision advice is stored in the advice storage unit, in a state of being associated with the analysis information and the specific information, in a case where a difference between the provision advice and the advice candidate satisfies a predetermined condition.

3. The advice providing system according to claim 1, further comprising:
an advice candidate display unit on which the advice candidate is displayed; and
an editing unit that selects one from among the displayed advice candidates, deletes, adds, or changes one portion or all portions of a statement that is included in the selected advice candidate, and thus generates the edit advice.

4. The advice providing system according to claim 1, further comprising:
a detector that detects the exercise data of the subject; and
a provision advice display unit on which the provision advice that is created based on the exercise data is displayed.

5. The advice providing system according to claim 1,
wherein the specific information includes at least one among an identification number for identifying the subject, a full name, a height, a weight, a birth date, a gender, a district, an exercise purpose, job information, and disease information.

6. The advice providing system according to claim 1,
wherein the exercise data includes at least one among the number of days on which exercise takes place, an amount of exercise time, exercise intensity, consumed calories, and a tendency for weight to change, an amount of device-wearing time, and an amount of zone-staying time.

7. The advice providing system according to claim 1, comprising:
a terminal device that includes
the detector,
the provision advice display unit and
a terminal communicator that transmits the exercise data and receives the provision advice;
an advice providing apparatus that includes
the advice candidate display unit,
the editing unit,
the determiner, and
a provision apparatus communicator that receives the advice candidate and transmits the provision advice, and
an advice providing server that includes
the advice storage unit,
the advice retrieval unit, and
a server communicator that receives the exercise data, transmits the advice candidate, and transmits and receives the provision advice.

8. The advice providing system according to claim 1,
wherein the analysis information includes at least one among the number of elapsed days for a guidance program, a physical strength level, a consumed-calories accomplishment rate, the number of days for exercise, an amount of exercise time, an amount of zone-staying time in every pulse rate band, exercise intensity, an increase or decrease in consumed calories, an amount of device wearing time, a tendency for weight to change, and a tendency for BMI to change.

9. An advice providing apparatus comprising:
an advice storage unit in which analysis information that results from analysis based on exercise data of a subject, specific information of the subject, and advice information that is provided to the subject are stored associated with one another;
an advice retrieval unit that retrieves at least one advice candidate from the advice storage unit based on at least one piece of information of the analysis information and the specific information;
a determiner that determines edit advice that results from performing editing referring to the advice candidate, as provision advice that is provided to the subject;
a display unit on which the advice candidate is displayed; and
an editing unit that selects one from among the displayed advice candidates, deletes, adds, or changes one portion or all portions of a statement that is included in the selected advice candidate, and thus generates the edit advice.

10. The advice providing apparatus according to claim 9,
wherein, in a case where a difference between the edit advice and the advice candidate satisfies a predetermined condition, the edit advice is stored in the advice storage unit, in a state of being associated with at least one piece of information of the analysis information and the specific information.

11. The advice providing apparatus according to claim 9, further comprising:
a display unit on which the multiple advice candidates are displayed; and
an editing unit that selects one from among the displayed advice candidates, deletes, adds, or changes one portion or all portions of a statement that is included in the selected advice candidate, and thus generates the edit advice.

12. The advice providing apparatus according to claim 9, further comprising:
a communicator that acquires the exercise data of the subject,
wherein the edit advice that is created using the exercise data is displayed on the display unit.

13. The advice providing apparatus according to claim 9,
wherein the specific information includes at least one among an identification number for identifying the subject, a full name, a height, a weight, a birth date, a gender, a district, an exercise purpose, job information, and disease information.

14. The advice providing apparatus according to claim 9,
wherein the exercise data includes at least one among the number of days on which exercise takes place, an amount of exercise time, exercise intensity, consumed calories, and a tendency for weight to change, an amount of device-wearing time, and an amount of zone-staying time.

15. The advice providing apparatus according to claim 9,
wherein the analysis information includes at least one among the number of elapsed days for a guidance program, a physical strength level, a consumed-calories accomplishment rate, the number of days for exercise, an amount of exercise time, an amount of zone-staying time in every pulse rate band, exercise intensity, an increase or decrease in consumed calories, an amount of device wearing time, a tendency for weight to change, and a tendency for BMI to change.

16. An advice providing server comprising:
an advice storage device in which analysis information that results from analysis based on exercise data of a subject, specific information of the subject, and advice information that is provided to the subject are stored associated with one another;
an advice retrieval unit that retrieves at least one advice candidate from the advice storage unit, based on at least one piece of information of the analysis information and the specific information; and
a determiner that determines edit advice that results from performing editing referring to the advice candidate, as provision advice that is provided to the subject.

17. A method of providing advice, comprising:
storing analysis information that results from analysis based on exercise data of a subject, specific information of the subject, and advice information that is provided to the subject, which are associated with one another, in a database;
retrieving at least one advice candidate from the database, based on at least one piece of information of the analysis information and the specific information; and
determining edit advice that results from performing editing referring to the advice candidate, as provision advice that is provided to the subject.
